(19) United States
(12) Patent Application Publication
(10) Pub. No.: US 2023/0037499 A1
(43) Pub. Date: Feb. 9, 2023

(54) MODEL GENERATION DEVICE, IN-VEHICLE DEVICE, AND MODEL GENERATION METHOD

(71) Applicant: Mitsubishi Electric Corporation, Tokyo (JP)

(72) Inventors: Taro OKUDA, Tokyo (JP); Genki TANAKA, Tokyo (JP)

(73) Assignee: Mitsubishi Electric Corporation, Tokyo (JP)

(21) Appl. No.: 17/791,945

(22) PCT Filed: Feb. 17, 2020
(86) PCT No.: PCT/JP2020/005937

§ 371 Date: Jul. 11, 2022

(51) Int. Cl. G06F 9/48; G06F 9/345

(52) U.S. Cl. CPC G06F 9/4881; G06F 9/345; G06N 3/04

(57) ABSTRACT

Provided are: a selection information acquiring unit to acquire selection information for identifying a target model to be generated from among a plurality of generable neural network models; a model identification unit to identify the target model on the basis of the selection information acquired by the selection information acquiring unit; a weight acquiring unit to acquire a weight of the target model identified by the model identification unit; and a model generation unit to generate the target model identified by the model identification unit on the basis of the weight acquired by the weight acquiring unit and a weight map in which structure information on a structure of each of the plurality of neural network models and information for mapping a weight in the structure are defined.

### TECHNICAL FIELD

The present disclosure relates to a model generation device that generates a neural network model, an in-vehicle device equipped with the model generation device, and a model generation method.

### BACKGROUND ART

In recent years, there has been known a technique of obtaining pieces of information suitable for various conditions by performing computation using various neural network models suitable for the various conditions (e.g., Patent Literature 1). Herein, the “neural network model” means a learned model learned using deep learning in a neural network.

### CITATION LIST

### Patent Literature

Patent Literature 1: Japanese Patent Laid-Open Publication No. 2018-81404

### SUMMARY OF INVENTION

### Technical Problem

In general, the size of data indicating the neural network model is large. Therefore, there has been a problem that a device for performing computation using the neural network model cannot store all data indicating various neural network models suitable for various conditions.

The present disclosure has been made to solve the above-described problem, and an object of the present disclosure is to provide a model generation device which makes it possible to obtain pieces of information suitable for various conditions without requiring storage of all data indicating various neural network models suitable for the various conditions.

### Solution to Problem

A model generation device according to the present disclosure includes: a selection information acquiring unit to acquire selection information for identifying at least one target model to be generated from among a plurality of generable neural network models; a model identification unit to identify the at least one target model on the basis of the selection information acquired by the selection information acquiring unit; a weight acquiring unit to acquire a weight of the at least one target model identified by the model identification unit; and a model generation unit to generate the at least one target model identified by the model identification unit on the basis of the weight acquired by the weight acquiring unit and a weight map in which structure information on a structure of each of the plurality of neural network models and information for mapping a weight in the structure are defined.

### Advantageous Effects of Invention

According to the present disclosure, it is possible to obtain pieces of information suitable for various conditions without requiring storage of all data indicating various neural network models suitable for the various conditions.

### BRIEF DESCRIPTION OF DRAWINGS

FIG. 1 is a diagram illustrating a configuration example of a model generation device according to a first embodiment.

FIG. 2 is a diagram for explaining a concept of an example of model identification information referred to by a model identification unit in the first embodiment.

FIG. 3 is a diagram for explaining a concept of an example of weight information in which weights are stored, in the first embodiment.

FIG. 4 is a flowchart for explaining the operation of the model generation device according to the first embodiment.

FIG. 5 is a diagram illustrating a configuration example of a model generation device according to a second embodiment.

FIG. 6 is a flowchart for explaining the operation of the model generation device according to the second embodiment.

FIG. 7 is a diagram illustrating a configuration example of a model generation device according to a third embodiment.

FIG. 8 is a flowchart for explaining the operation of the model generation device according to the third embodiment.

FIGS. 9A and 9B are diagrams each illustrating an example of hardware configuration of the model generation devices according to the first to third embodiments.

### DESCRIPTION OF EMBODIMENTS

Hereinafter, embodiments of the present disclosure will be described in detail with reference to the drawings.

### First Embodiment

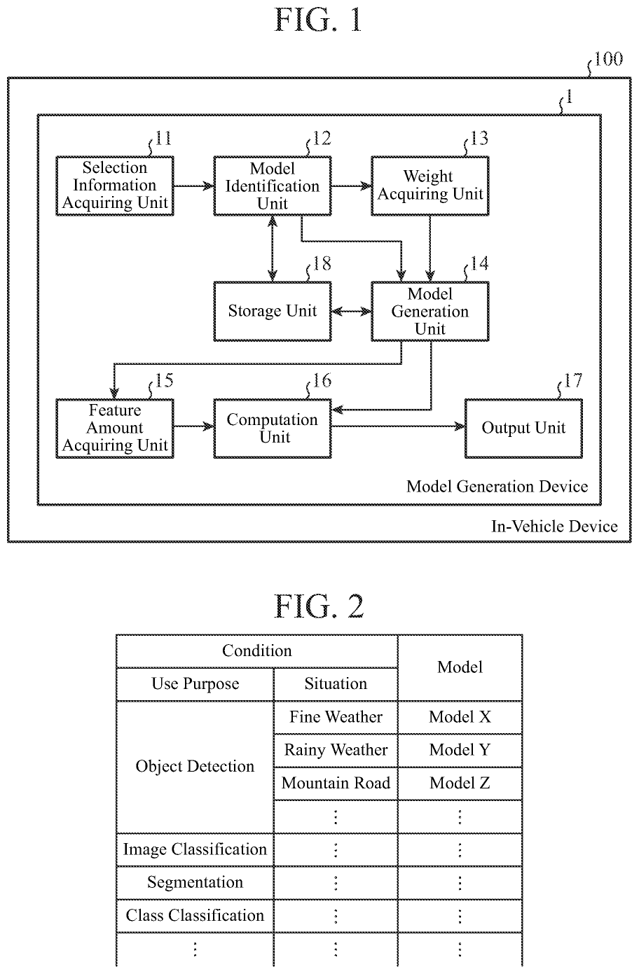

FIG. 1 is a diagram illustrating a configuration example of a model generation device 1 according to a first embodiment.

In the first embodiment, the model generation device 1 generates a neural network model. The model generation device 1 generates a neural network model not on the basis of learning but on the basis of a weight map and weights acquired from, for example, a device outside the model generation device 1. Details of the weight map and the weight will be described later.

The model generation device 1 can generate a plurality of neural network models. The neural network models that can be generated by the model generation device 1 are decided in advance. Hereinafter, the neural network model that can be generated by the model generation device 1 is also simply referred to as a “model.”

In the first embodiment, the model generation device 1 is assumed to be mounted on an in-vehicle device 100 mounted on a vehicle. The in-vehicle device 100 is assumed to be, for example, a vehicle control device that performs driving control of the vehicle. The model generation device 1 generates a model for driving assistance used when the vehicle control device performs driving control of the vehicle.

As illustrated in FIG. 1, the model generation device 1 includes a selection information acquiring unit 11, a model identification unit 12, a weight acquiring unit 13, a model generation unit 14, a feature amount acquiring unit 15, a computation unit 16, an output unit 17, and a storage unit 18.

The selection information acquiring unit 11 acquires information (hereinafter referred to as “selection information”) for identifying a model to be generated (hereinafter referred to as a “target model”) from among the plurality of models that can be generated by the model generation device 1. Note that the content of the information to be the selection information is decided in advance depending on the model that can be generated by the model generation device 1.

First, for example, the selection information acquiring unit 11 acquires sensor information output from a sensor (not illustrated) mounted on the vehicle, image information obtained by imaging an area around the vehicle by an imaging device (not illustrated) mounted on the vehicle, information on a position of the vehicle output from a global positioning system (GPS, not illustrated) mounted on the vehicle, topographical information output from the GPS, road information stored in a map server (not illustrated) present outside the vehicle, weather information stored in a weather server (not illustrated) present outside the vehicle, or information designating a use mode input by user's manipulation of an input device (not illustrated).

On the basis of the acquired information, the selection information acquiring unit 11 acquires the selection information. Specifically, for example, on the basis of information in which a human detection mode is designated as the use mode, the selection information acquiring unit 11 determines that the information is information in which “object detection” is designated as a use purpose of the model, and thus acquires, as the selection information, information designating “object detection”. It is assumed that which use mode is designating which use purpose of the model is determined in advance. Herein, it is assumed that the human detection mode is designating “object detection.”

Furthermore, for example, the selection information acquiring unit 11 acquires information indicating “rainy weather” or “fine weather” as the selection information on the basis of the weather information. Further, for example, the selection information acquiring unit 11 acquires information indicating a road type such as information indicating a “mountain road” as the selection information on the basis of the road information. For example, the selection information acquiring unit 11 may acquire information indicating “rainy weather,” “fine weather,” or “mountain road” as the selection information on the basis of the image information. The selection information acquiring unit 11 may acquire the selection information from the image information using, for example, an existing technology such as an image recognition technology.

The selection information acquiring unit 11 acquires, as the selection information, one or more pieces of information from among the information indicating “rainy weather,” the information indicating “fine weather,” the information indicating “mountain road,” and the like as described above.

The selection information acquiring unit 11 outputs the acquired selection information to the model identification unit 12.

The model identification unit 12 identifies the target model on the basis of the selection information acquired by the selection information acquiring unit 11.

Specifically, by referring to model identification information, the model identification unit 12 identifies the target model on the basis of the selection information acquired by the selection information acquiring unit 11. The model identification information is information in which a condition and a model are associated with each other. In the model identification information, a model with high reliability is associated depending on a condition.

The model identification information is generated in advance at the time of product shipment or the like of the model generation device 1, and is stored in the storage unit 18.

FIG. 2 is a diagram for explaining a concept of an example of the model identification information referred to by the model identification unit 12 in the first embodiment.

In the model identification information illustrated in FIG. 2, the use purpose of the model and the situation when the model is used are defined as conditions.

According to the model identification information illustrated in FIG. 2, for example, in a case where the use purpose of the model is “object detection” and the situation when the model is used is “fine weather,” the model with high reliability as the model to be used is “model X.”

On the basis of the selection information, the model identification unit 12 searches for a condition matching the selection information in the model identification information. When finding the condition matching the selection information in the model identification information, the model identification unit 12 identifies the model associated with the found condition as the target model.

For example, it is assumed that the selection information acquired by the selection information acquiring unit 11 includes information indicating “object detection” and information indicating rainy weather. Moreover, it is assumed that the model identification information has contents as illustrated in FIG. 2.

In this case, the model identification unit 12 identifies “model Y” as the target model.

The model identification unit 12 outputs information on the identified target model to the weight acquiring unit 13 and the model generation unit 14.

Note that the model identification information illustrated in FIG. 2 is merely an example. The model identification information may be any information that defines information which makes it possible to identify, on the basis of the selection information acquired by the selection information acquiring unit 11, the target model to be generated by the model generation device 1.

The weight acquiring unit 13 acquires the weight of the target model identified by the model identification unit 12.

Specifically, the weight acquiring unit 13 refers to weight information in which weights to be used in generating each model are classified and stored, and thereby acquires the weight of the target model from the weight information.

The weights are stored in a storage device (not illustrated) that is provided outside the vehicle and can be referred to by the model generation device 1. For example, the storage device is provided in a server present outside the vehicle. The storage device includes, for example, a hard disk drive (HDD) or a super density disc (SDD).

The size of data indicating the weight of the model is large, and thus the capacity of the storage device that stores the weight is large. The model generation device 1 acquires the weight of the model requiring a particularly large storage capacity from the storage device outside the vehicle, so that it is unnecessary for the in-vehicle device 100 including the vehicle control device to store all the weights of the models that can be generated, and thus the storage region in the in-vehicle device 100 is allowed to have more empty space.

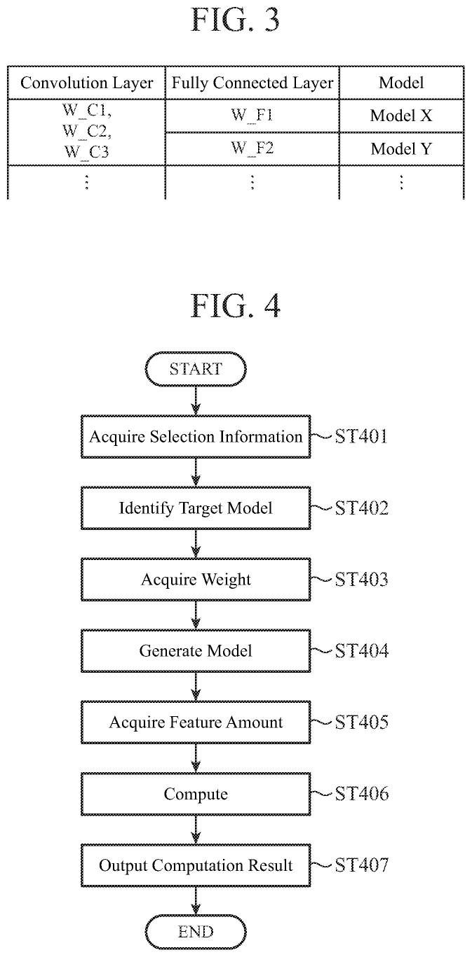

FIG. 3 is a diagram for explaining a concept of an example of the weight information in which weights are stored, in the first embodiment.

FIG. 3 illustrates, as an example, a concept of weight information in which weights of the model X and the model Y are classified and stored.

Herein, as an example, the model X is a model having a model structure S_X including three convolution layers+one fully connected layer, and the model Y is a model having a model structure S_Y including three convolution layers+one fully connected layer. In the model X, the weights in the convolution layers are W_C1, W_C2, and W_C3, and the weight in the fully connected layer is W_F1. In the model Y, the weights in the convolution layers are W_C1, W_C2, and W_C3, and the weight in the fully connected layer is W_F2.

Note that, herein, for simplicity of explanation, one or more weights in a certain layer are collectively expressed. For example, in the model X, the weight of a certain layer among the three convolution layers is expressed as W_C1, and W_C1 collectively represents one or more weights each indicating a coupling state between one or more nodes and one or more nodes of the certain layer.

For example, as illustrated in FIG. 3, the weight information can be information in which weights of respective layers are classified. In FIG. 3, the weight information is information in which weights of respective convolution layers are classified.

As described above, the model X and the model Y have the same structure and have the same weights in the convolution layers. Note that, in general, in a neural network, it is known that when a plurality of models differ in the weight of a part of layers in a subsequent stage of the structure of the model, the models have high accuracy for different use purposes or under different conditions. The preceding stage of the structure of the model specifically refers to a range from the input layer to one or more convolution layers following the input layer. On the other hand, the subsequent stage of the structure of the model specifically refers to a range after the preceding stage in the structure of the model, the range including the fully connected layer.

By setting, as the weight information, information in which weights of respective convolution layers are classified and stored, it is possible to centrally manage common weights in the convolution layers, and thus it is possible to store the weights of a plurality of models by using minimum necessary combinations. In this manner, by storing the weights of the plurality of models by using the minimum necessary combinations, the storage region for storing the weights in the storage device can be reduced.

In the first embodiment, as described above, the storage device that stores the weights is provided outside the vehicle. However, this is merely an example. As illustrated in FIG. 3, in a case where a plurality of models that can be generated by the model generation device 1 include two or more models which have common weights in the convolution layers and whose common weights can be centrally managed, the storage device that stores the weights may be provided inside the vehicle. This is because even if the storage device is provided inside the vehicle, the storage region for the common weights can be reduced by centrally managing the common weights of the models.

Note that the concept of the weight information illustrated in FIG. 3 is merely an example. For example, the weight information may be information in which weights of respective models are classified and stored, or may be information in which weights each corresponding to one weight are classified and stored. The weight information may be any information in which weights of a plurality of models that can be generated by the model generation device 1 are stored.

Now, it is assumed that the model Y is identified as the target model by the model identification unit 12. It is assumed that the weight information has contents as illustrated in FIG. 3. In this case, the weight acquiring unit 13 acquires “W_C1, W_C2, W_C3, and W_F2” as the weight of the model Y.

The weight acquiring unit 13 outputs the acquired weight of the target model to the model generation unit 14.

The model generation unit 14 generates the target model on the basis of the weight map and the weight of the target model acquired by the weight acquiring unit 13.

The weight map is information in which structure information regarding the structures of models and information for mapping weights in the structures are defined. As to the weights to be mapped in the structures of the models, the weight map defines how to assign weights of respective models, weights of respective layers, or weights each corresponding to one weight. Herein, each of the weights of respective models is a group of weights of one model such as ConvNet. Each of the weights of respective layers is a group of weights of one layer such as Conv2D_1 or Conv2D_2. Each of the weights each corresponding to one weight is merely a numerical value such as −0.3 or 0.2.

The weight map is generated in advance and stored in the storage unit 18.

As a specific example of the weight map, for example, for the above-described model Y, structure information indicating the model structure S_Y and information indicating where to map the weights W_C1, W_C2, W_C3, and W_F2 are defined in the weight map. The structure information includes, for example, information on the number of intermediate layers, the number of nodes in each layer, and a node connection state between layers.

In the weight map, in addition to the structure information regarding the structures of models and the information for mapping weights in the structures, information which makes it possible to identify a device that performs computation using the model may be associated.

The device that performs computation using the model is, for example, a central processing unit (CPU), a graphics processing unit (GPU), or a field-programmable gate array (FPGA).

The model generation unit 14 generates the target model not on the basis of learning but on the basis of the weight map and the weight acquired by the weight acquiring unit 13. After generating the target model, the model generation unit 14 notifies the feature amount acquiring unit 15 and the computation unit 16 that the target model has been generated.

Moreover, the model generation unit 14 loads the generated target model into a device that performs computation using the target model. The model generation unit 14 may identify a device that performs computation using the target model, for example, on the basis of the weight map. Furthermore, information in which models that can be generated by the model generation device 1 are associated with devices that perform computation using the models (hereinafter referred to as “device identification information”) may be stored in the storage unit 18 in advance. The model generation unit 14 may identify a device that performs computation using the target model on the basis of the device identification information.

Note that, in a case where the model generation unit 14 identifies the device on the basis of the weight map, the device can be identified only by acquiring the weight map, and thus the device that performs the computation using the target model can be efficiently identified as compared with a case where the device identification information is acquired separately from the weight map.

The feature amount acquiring unit 15 acquires a feature amount to be input to the target model generated by the model generation unit 14.

Specifically, for example, the feature amount acquiring unit 15 first acquires sensor information output by the sensor mounted on the vehicle, image information obtained by imaging an area around the vehicle by the imaging device mounted on the vehicle, information regarding the position of the vehicle output by the GPS mounted on the vehicle, topographical information output by the GPS, road information stored in the map server, weather information stored in the weather server, or information designating a use mode input by the user's manipulation of the input device. Then, the feature amount acquiring unit 15 acquires the feature amount on the basis of the acquired information. The feature amount acquiring unit 15 may acquire the feature amount using an existing technology such as an image recognition technology. Note that what kind of feature amount is input is decided in advance for each model.

The feature amount acquiring unit 15 outputs the acquired feature amount to the computation unit 16.

The computation unit 16 performs computation using the target model generated by the model generation unit 14 on the basis of the feature amount acquired by the feature amount acquiring unit 15.

In a case where computation is performed using a model other than the target model before the model generation unit 14 generates the target model, the computation unit 16 switches computation to be performed from the computation using the model other than the target model to computation using the target model. As a specific example, for example, it is assumed that the weather has changed from fine weather to rainy weather when the computation unit 16 is performing computation for object detection using a model with high accuracy in fine weather (hereinafter, it is referred to as a “fine weather period model”) in fine weather. In this case, on the basis of the selection information acquired by the selection information acquiring unit 11, the model identification unit 12 identifies a model with high accuracy in rainy weather as the target model. For example, when the model identification information has contents as shown in FIG. 2, the fine weather period model is the model X. The model identification unit 12 identifies the model Y as the target model. The weight acquiring unit 13 acquires the weight of the model Y, and thereby the model generation unit 14 generates the model Y. After generating the model Y, the model generation unit 14 notifies the computation unit 16 that the model Y has been generated.

Upon receiving the notification from the model generation unit 14, the computation unit 16 switches from the computation for object detection using the model X to the computation for object detection using the model Y.

The timing at which the computation unit 16 switches the model used for the computation from the model X to the model Y may be any timing. For example, the computation unit 16 may detect a state in which the model Y is loaded on the device and computation using the model Y becomes possible by some method, and switch from the model X to the model Y when the state is detected. Examples of a method of detecting a state in which the computation using the model Y becomes possible include a method of detecting the state by measuring the time from when the model Y is loaded on the device, and a method of detecting the state by determining whether or not a notification indicating that the model Y has been loaded has been made by the model generation unit 14. Furthermore, for example, when switching the model, the computation unit 16 may stop the computation using the model X for a preset time and then perform the computation using the model Y.

The computation unit 16 outputs a result of computation performed, on the basis of the feature amount acquired by the feature amount acquiring unit 15, using the target model generated by the model generation unit 14 to the output unit 17.

In the above example, the computation unit 16 outputs a result of computation for object detection performed using the model Y to the output unit 17.

The output unit 17 outputs the computation result output from the computation unit 16. For example, the output unit 17 outputs the computation result to the vehicle control device. The vehicle control device performs driving control of the vehicle on the basis of the computation result output by the output unit 17.

The storage unit 18 stores the model identification information and the weight map.

In FIG. 1, the storage unit 18 is provided in the model generation device 1, but this is merely an example. The storage unit 18 may be provided outside the model generation device 1 at a place that can be referred to by the model generation device 1. For example, the storage unit 18 may be provided in the vehicle control device.

The operation of the model generation device 1 according to the first embodiment will be described.

FIG. 4 is a flowchart for explaining the operation of the model generation device 1 according to the first embodiment.

The operation of the model generation device 1 will be explained with reference to FIG. 4, taking, as an example, a case where the weather changes from fine weather to rainy weather while the model generation device 1 has been performing computation for object detection using the fine weather period model in fine weather. Note that that there is no change in the use mode between when the weather is fine and when the weather is rainy. The device that performs computation using the fine weather period model is the device A.

Moreover, it is assumed that the model identification information has contents as illustrated in FIG. 2. Therefore, the fine weather period model is the model X. It is assumed that the weight information has contents as illustrated in FIG. 3.

The selection information acquiring unit 11 acquires selection information (step ST 401).

Herein, it is assumed that the selection information acquiring unit 11 has acquired selection information including information indicating object detection and information indicating rainy weather.

The selection information acquiring unit 11 outputs the acquired selection information to the model identification unit 12.

The model identification unit 12 identifies the target model on the basis of the selection information acquired by the selection information acquiring unit 11 in step ST 401 (step ST 402).

Herein, the model identification unit 12 identifies, on the basis of the selection information including the information indicating the object detection and the information indicating rain weather, the model Y as the target model by referring to the model identification information.

The model identification unit 12 outputs information on the identified target model to the weight acquiring unit 13 and the model generation unit 14.

The weight acquiring unit 13 acquires the weight of the target model identified by the model identification unit 12 in step ST 402 (step ST 403).

Herein, the weight acquiring unit 13 refers to the weight information and thereby acquires “W_C1, W_C2, W_C3, and W_F2” as the weight of the model Y that is the target model.

The weight acquiring unit 13 outputs the acquired weight of the target model to the model generation unit 14.

The model generation unit 14 generates the target model on the basis of the weight map and the weight of the target model acquired by the weight acquiring unit 13 in step ST 403 (step ST 404).

Herein, the model generation unit 14 generates the model Y on the basis of the weight map and the weights “W_C1, W_C2, W_C3, and W_F2.” It is assumed that information indicating the device A as a device that performs computation using the model Y is associated in the weight map. The model generation unit 14 loads the generated model Y onto the device A. After generating the model Y, the model generation unit 14 notifies the feature amount acquiring unit 15 and the computation unit 16 that the model Y has been generated.

The feature amount acquiring unit 15 acquires a feature amount to be input to the target model generated by the model generation unit 14 in step ST404 (step ST405).

Herein, the feature amount acquiring unit 15 acquires a feature amount to be input to the model Y.

The feature amount acquiring unit 15 outputs the acquired feature amount to the computation unit 16.

The computation unit 16 performs, on the basis of the feature amount acquired by the feature amount acquiring unit 15 in step ST 405, computation using the target model generated by the model generation unit 14 in step ST 404 (step ST 406).

Herein, the computation unit 16 switches from the model X to the model Y on the device A and thereby performs computation for object detection using the model Y. The computation unit 16 inputs the feature amount acquired by the feature amount acquiring unit 15 in step ST 406 to the model Y, and thereby acquires information output by the model Y with high accuracy in rainy weather as a computation result.

The computation unit 16 outputs the computation result obtained as a result of performing computation for object detection using the model Y to the output unit 17.

The output unit 17 outputs the computation result output from the computation unit 16 in step ST406 (step ST 407). For example, the output unit 17 outputs the computation result to the vehicle control device. The vehicle control device controls the vehicle on the basis of the computation result output by the output unit 17.

As described above, the model generation device 1 identifies the target model on the basis of the selection information, and generates the target model not on the basis of learning but on the basis of the weight map and the weight. The model generation device 1 makes the storage device outside the vehicle store weights that consume a storage capacity tremendously, and acquires the weight from the storage device. The model generation device 1 allows a storage region in the in-vehicle device 100 to have more empty space. Therefore, the model generation device 1 makes it possible to obtain pieces of information suitable for various conditions, in other words, computation results obtained by performing pieces of computation using various models suitable for the various conditions, without requiring storage of all data indicating the various models.

In the first embodiment described above, as an example, an example has been described in which the model generation device 1 can generate models that have a common portion in structure and weight and are used for the same use purpose, such as the model X and the model Y. However, this is merely an example. The model generation device 1 can generate a plurality of models having different structures or weights. Moreover, the model generation device 1 can generate a plurality of models used for different use purposes.

Furthermore, in the first embodiment described above, as an example, the number of target models is one, but the number of target models may be plural. The model generation device 1 can generate a plurality of target models at once. The model generation device 1 can generate a plurality of target models by combining weights stored in the storage device outside the vehicle. As a specific example, for example, the model generation device 1 can generate two models used for different use purposes by combining weights, such as a model used for a use purpose “object detection” and a model used for a use purpose “segmentation”. Moreover, for example, the model generation device 1 can generate the same model to be loaded into two different devices for fail-safe.

Furthermore, in the first embodiment described above, all the weights of the models are stored in the storage device outside the vehicle, but this is merely an example. For example, among the weights of all the models that can be generated by the model generation device 1, some weights may be loaded in advance on devices as load destinations, and the remaining weights may be stored in the storage device outside the vehicle. As a specific example, for example, weights common to models that can be generated by the model generation device 1 may be loaded in advance on devices as load destinations. As a result, it is possible to reduce the load on the weight acquiring unit 13 to acquire the weight from the storage device.

Furthermore, in the first embodiment described above, the feature amount acquiring unit 15, the computation unit 16, and the output unit 17 are included in the model generation device 1, but the feature amount acquiring unit 15, the computation unit 16, and the output unit 17 do not necessarily need to be included in the model generation device 1. The feature amount acquiring unit 15, the computation unit 16, and the output unit 17 may be provided in a device outside the model generation device 1. For example, the feature amount acquiring unit 15, the computation unit 16, and the output unit 17 may be included in the vehicle control device.

A model generation device 1 according to the first embodiment includes: a selection information acquiring unit 11 to acquire selection information for identifying at least one target model to be generated from among a plurality of generable neural network models; a model identification unit 12 to identify the at least one target model on the basis of the selection information acquired by the selection information acquiring unit 11; a weight acquiring unit 13 to acquire a weight of the at least one target model identified by the model identification unit 12; and a model generation unit 14 to generate the at least one target model identified by the model identification unit 12 on the basis of the weight acquired by the weight acquiring unit 13 and a weight map in which structure information on a structure of each of the plurality of neural network models and information for mapping a weight in the structure are defined. Therefore, the model generation device 1 can make it possible to obtain pieces of information suitable for various conditions, in other words, computation results obtained by performing pieces of computation using various models suitable for the various conditions, without requiring storage of all data indicating the various models.

### Second Embodiment

In general, when a neural network model is operated on various devices, the neural network model may be optimized in a way depending on the neural network model and the device as hardware to be operated. By performing optimization depending on the neural network model and the hardware to be operated, the neural network can execute more optimal operation depending on the hardware than a case where optimization is not performed.

In a second embodiment, an embodiment will be explained in which, when a generated target model is loaded onto a device in a model generation device 1 a, the target model is optimized and then loaded.

Note that, in the second embodiment, “model optimization” includes compiling depending on an environment of a device that performs computation using a model, conversion of a model format depending on the environment of the device, the operation performed to further improve performance of the model after the conversion of the model format, or the like. The operation performed to further improve the performance of the model after the conversion of the model format is quantization, optimization of a computation method at the time of compiling, or the like.

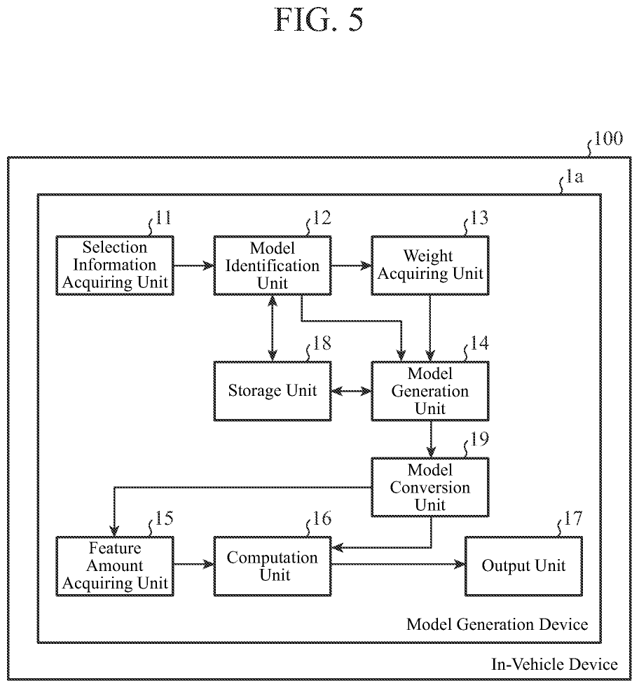

FIG. 5 is a diagram illustrating a configuration example of the model generation device 1a according to the second embodiment.

In FIG. 5, the same components as those of the model generation device 1 explained in the first embodiment with reference to FIG. 1 are denoted by the same reference signs, and redundant explanation is omitted.

The model generation device 1a according to the second embodiment is different from the model generation device 1 according to the first embodiment in that the model generation device 1a includes a model conversion unit 19.

The model conversion unit 19 optimizes the target model generated by the model generation unit 14 in a way depending on the target model and a device that performs computation by using the target model. The model optimization performed by the model conversion unit 19 is, for example, a deep learning compiler such as TFcompile or Tensor Virtual Machine (TVM). Since the deep learning compiler is a known technique, a detailed description thereof will be omitted.

In the second embodiment, when generating the target model, the model generation unit 14 notifies the model conversion unit 19 that the target model has been generated. At this time, the model generation unit 14 also notifies the model conversion unit 19 of information regarding a device that performs computation using the target model. The model conversion unit 19 may acquire the information regarding a device that performs computation using the target model from, for example, the model generation unit 14.

For example, when a device that performs computation using the target model is a CPU, the model conversion unit 19 performs optimization for the CPU. For example, when a device that performs computation using the target model is a GPU, the model conversion unit 19 performs optimization for the GPU. For example, when a device that performs computation using the target model is an FPGA, the model conversion unit 19 performs optimization for the FPGA.

Note that the model conversion unit 19 also performs quantization as necessary when performing optimization.

The type of optimization performed by the model conversion unit 19 is decided in advance for each device and for each model. That is, the type of optimization performed by the model conversion unit 19 is decided in advance depending on which model is the target model to be optimized and which device performs the computation using the target model.

Information on the type of optimization to be performed is stored in the storage unit 18 at the time of product shipment of the model generation device 1, for example. Furthermore, the information on the type of optimization to be performed may be stored in advance in a place that can be referred to by the model generation device 1 via a network, and that is outside the model generation device 1, for example.

After optimizing the target model, the model conversion unit 19 notifies the feature amount acquiring unit 15 and the computation unit 16 that the target model has been optimized.

The model conversion unit 19 loads the optimized target model into the device.

The operation of the model generation device 1a according to the second embodiment will be described.

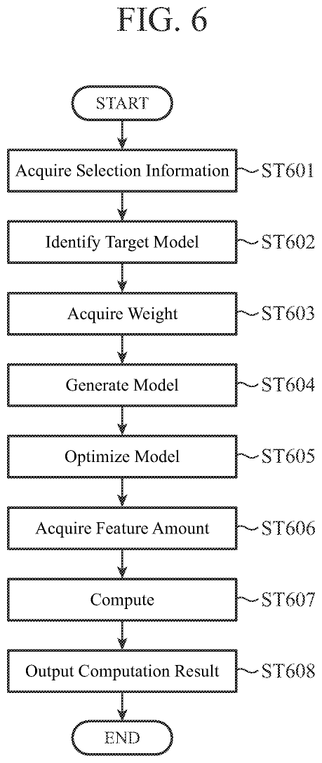

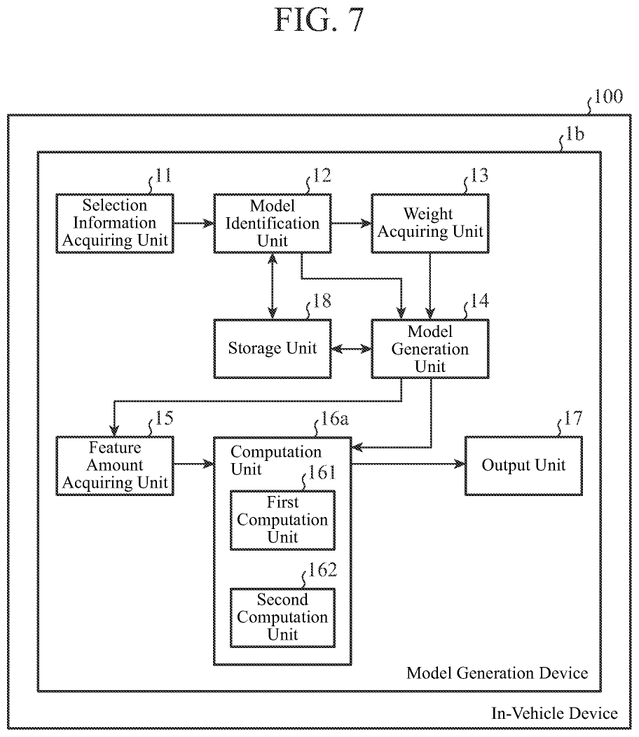

FIG. 6 is a flowchart for explaining the operation of the model generation device 1a according to the second embodiment.

The operation of the model generation device 1a will be explained with reference to FIG. 6, taking, as an example, a case where the weather changes from fine weather to rainy weather while the model generation device 1a has been performing computation for object detection using the fine weather period model in fine weather. The device that performs computation using the fine weather period model is the device A.

Moreover, it is assumed that the model identification information has contents as illustrated in FIG. 2. That is, the fine weather period model is the model X. It is assumed that the weight information has contents as illustrated in FIG. 3.

Specific operations of steps ST601 to ST604 and steps ST606 to ST608 in FIG. 6 are similar to the specific operations of steps ST401 to ST407 in FIG. 4 described in the first embodiment, respectively, and thus redundant description will be omitted.

In step ST604, the model generation unit 14 generates a target model. Herein, the model generation unit 14 generates the model Y.

The model generation unit 14 notifies the model conversion unit 19 that the model Y has been generated. At this time, the model generation unit 14 also notifies that the device that performs computation using the model Y is the device A.

The model conversion unit 19 optimizes the target model in a way depending on the target model generated by the model generation unit 14 in step ST604 and the device that performs computation using the target model (step ST605). Herein, the model conversion unit 19 performs optimization depending on the model Y and the device A. After optimizing the model Y, the model conversion unit 19 loads the optimized model Y onto the device A. After optimizing the model Y, the model conversion unit 19 notifies the feature amount acquiring unit 15 and the computation unit 16 that the model Y has been optimized.

Then, the model conversion unit 19 loads the optimized target model onto the device.

As described above, the model generation device 1a optimizes the target model and then loads the optimized target model onto a device that performs computation using the target model. There is no need to perform optimization processing when the device performs computation using the target model. Therefore, it is possible to reduce the processing load when the computation is performed using the target model.

As described above, according to the second embodiment, the model generation device 1a includes the model conversion unit 19 that optimizes the target model generated by the model generation unit 14 in a way depending on the target model and the device that performs computation using the target model, and loads the optimized target model into the device. Therefore, the model generation device 1a can reduce the processing load when performing computation using the target model.

### Third Embodiment

As described above, in general, in a neural network, it is known that when a plurality of models differ in the weight of a part of layers in a subsequent stage of the structure of the model, the models have high accuracy for different use purposes or under different conditions. That is, when a plurality of models have a common structure and a common weight in a preceding stage of the structure of the model, and differ in a part of the structure or the weight in a subsequent stage of the structure of the model, the plurality of models have high accuracy for different use purposes or under different conditions.

In a third embodiment, an embodiment will be described in which, when a model generation device 1b performs computation using a plurality of generated models, a computation result of a portion having a common structure and a common weight mapped in the structure is shared.

The third embodiment is based on the premise that the model generation unit 14 in the model generation device 1b can generate a plurality of models at once to which the same feature amount is to be input, and the plurality of models each have a portion having a common structure and a common weight mapped in the structure.

Note that, in a preceding stage of the structure of each of the plurality of models to which the same feature amount is to be input, the portion having a common structure and a common weight mapped in the structure is present.

FIG. 7 is a diagram illustrating a configuration example of the model generation device 1b according to the third embodiment.

In FIG. 7, the same components as those of the configuration example of the model generation device 1 explained in the first embodiment with reference to FIG. 1 are denoted by the same reference signs, and redundant explanation is omitted.

The model generation device 1b according to the third embodiment is different from the model generation device 1 according to the first embodiment in that a computation unit 16a includes a first computation unit 161 and a second computation unit 162.

When a plurality of target models generated by a model generation unit 14 are target models each having a portion having a common structure and a common weight mapped in the structure, the computation unit 16a causes the plurality of target models to share a result of computation performed using the portion.

Hereinafter, in the plurality of target models, the portion having a common structure and a common weight mapped in the structure is also simply referred to as a “common portion.”

More specifically, when two or more target models among the plurality of target models generated by the model generation unit 14 are target models each having a common portion, the first computation unit 161 uses, as an input, a feature amount acquired by a feature amount acquiring unit 15 and performs computation using only the common portion. Note that the first computation unit 161 performs computation using only the common portion once for the plurality of target models.

In the third embodiment, after generating a plurality of target models, the model generation unit 14 notifies the computation unit 16a of the generation of the plurality of target models and also notifies of the weight map. For example, in the weight map, each model is associated with information on whether or not the model is a model having a common portion with a different model, the different model in a case of having the common portion, and a weight map of the common portion.

On the basis of the weight map, the first computation unit 161 may identify whether or not the plurality of target models are models each having a common portion, and identify the weight map of the common portion in a case where the plurality of target models are models each having a common portion.

The first computation unit 161 outputs a computation result obtained by performing computation using only the common portion to the second computation unit 162.

When the plurality of target models generated by the model generation unit 14 do not include target models each having a common portion, the first computation unit 161 outputs information indicating that there is no target model having a common portion to the second computation unit 162. Moreover, when the plurality of target models generated by the model generation unit 14 include a target model having no common portion in addition to target models each having a common portion, the first computation unit 161 outputs information for identifying the target model having no common portion to the second computation unit 162.

For each of the plurality of target models each having a common portion, the second computation unit 162 performs computation which uses the computation result output from the first computation unit 161 as an input, and which uses a portion other than the common portion among the structures of the plurality of target models.

The second computation unit 162 outputs, to the output unit 17, a computation result obtained by performing the computation using a portion other than the common portion for each of the plurality of target models each having the common portion, as a final computation result of using the target model. At this time, when information for identifying a target model which has no common portion and which is other than the target models each having the common portion is output from the first computation unit 161, the second computation unit 162 performs, for the target model having no common portion, computation using the target model on the basis of the feature amount acquired by the feature amount acquiring unit 15. Then, the second computation unit 162 adds a computation result obtained by performing the computation using the target model having no common portion to the final computation result of using the target model.

When information indicating that there is no target model having a common portion is output from the first computation unit 161, the second computation unit 162 performs, for each of the plurality of target models generated by the model generation unit 14, computation using the target model on the basis of the feature amount acquired by the feature amount acquiring unit 15. The second computation unit 162 outputs a computation result obtained by performing the computation using each of the plurality of target models generated by the model generation unit 14 to the output unit 17 as a final computation result of using the target model.

The operation of the model generation device 1b according to the third embodiment will be described.

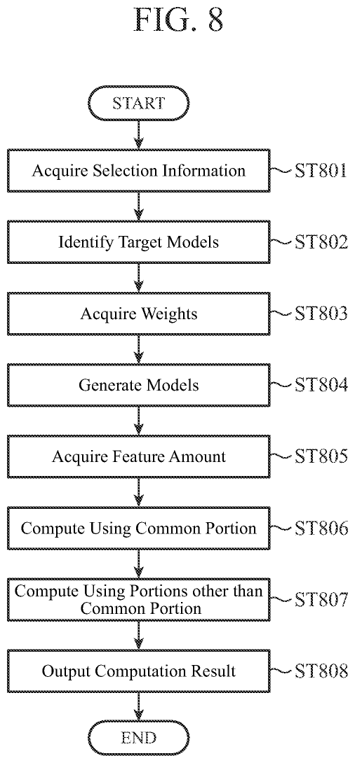

FIG. 8 is a flowchart for explaining the operation of the model generation device 1b according to the third embodiment.

Specific operations of step ST801 to step ST805 and step ST808 in FIG. 8 are similar to the specific operations of step ST401 to step ST407 in FIG. 4 described in the first embodiment, and thus redundant description will be omitted.

Note that, in the third embodiment, in step ST802, the model identification unit 12 identifies a plurality of models as a plurality of target models, and in step ST804, the model generation unit 14 generates the plurality of target models.

When two or more target models among the plurality of target models generated by the model generation unit 14 in step ST804 are target models each having a common portion, the first computation unit 161 uses, as an input, a feature amount acquired by the feature amount acquiring unit 15 and performs computation using only the common portion (step ST806). Note that the first computation unit 161 performs computation using only the common portion once for the plurality of target models.

The first computation unit 161 outputs a computation result obtained by performing computation using only the common portion to the second computation unit 162.

When the plurality of target models generated by the model generation unit 14 do not include target models each having a common portion, the first computation unit 161 outputs information indicating that there is no target model having a common portion to the second computation unit 162. Moreover, when the plurality of target models generated by the model generation unit 14 include a target model having no common portion in addition to target models each having a common portion, the first computation unit 161 outputs information for identifying the target model having no common portion to the second computation unit 162.

For each of the plurality of target models each having a common portion, the second computation unit 162 performs computation which uses the computation result output from the first computation unit 161 in step ST806 as an input, and which uses a portion other than the common portion among the structures of the plurality of target models (step ST807).

The second computation unit 162 outputs, to the output unit 17, a computation result obtained by performing the computation using a portion other than the common portion for each of the plurality of target models each having the common portion, as a final computation result of using the target model. At this time, when information for identifying a target model which has no common portion and which is other than the target models each having the common portion is output from the first computation unit 161, the second computation unit 162 performs, for the target model having no common portion, computation using the target model on the basis of the feature amount acquired by the feature amount acquiring unit 15. Then, the second computation unit 162 adds a computation result obtained by performing the computation using the target model having no common portion to the final computation result of using the target model.

When information indicating that there is no target model having a common portion is output from the first computation unit 161, the second computation unit 162 performs, for each of the plurality of target models generated by the model generation unit 14, computation using the target model on the basis of the feature amount acquired by the feature amount acquiring unit 15. The second computation unit 162 outputs a computation result obtained by performing the computation using each of the plurality of target models generated by the model generation unit 14 to the output unit 17 as a final computation result of using the target model.

As described above, according to the third embodiment, in the model generation device 1b, the model generation unit 14 generates a plurality of target models at once to which the same feature amount is to be input. The plurality of target models each have a portion having a common structure and a common weight mapped in the structure. In a case where the plurality of target models generated by the model generation unit 14 each have the portion having the common structure and the common weight mapped in the structure, the computation unit 16a causes the plurality of target models to share a result of computation performed using the portion. Therefore, the model generation device 1b can reduce the time required for computation using the target models and can reduce the computation amount.

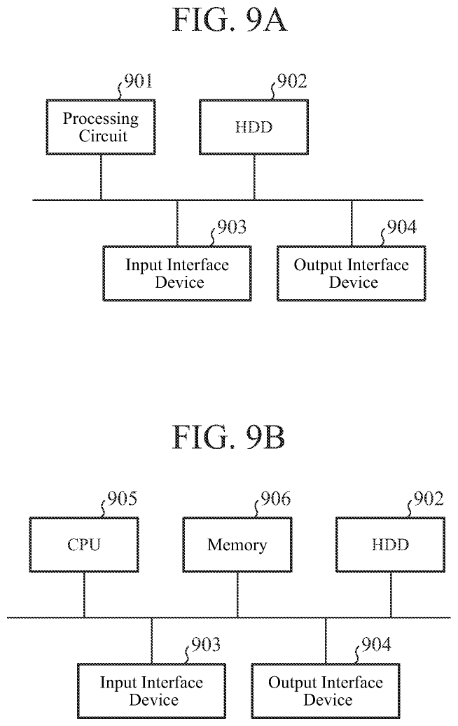

FIGS. 9A and 9B are diagrams each illustrating an example of hardware configuration of the model generation devices 1, 1a, and 1b according to the first to third embodiments.

In the first to third embodiments, the functions of the selection information acquiring unit 11, the model identification unit 12, the weight acquiring unit 13, the model generation unit 14, the feature amount acquiring unit 15, the computation units 16 and 16a, the output unit 17, and the model conversion unit 19 are implemented by a processing circuit 901. That is, the model generation devices 1, 1a and 1b each include the processing circuit 901 for performing control to generate the neural network model on the basis of the weight map and the weight acquired from, for example, a device outside the model generation device 1.

The processing circuit 901 may be dedicated hardware as illustrated in FIG. 9A, or may be a CPU 905 that executes a program stored in a memory 906 as illustrated in FIG. 9B.

In a case where the processing circuit 901 is dedicated hardware, the processing circuit 901 corresponds to, for example, a single circuit, a composite circuit, a programmed processor, a parallel programmed processor, an application specific integrated circuit (ASIC), an FPGA, or a combination thereof.

In a case where the processing circuit 901 is the CPU 905, the functions of the selection information acquiring unit 11, the model identification unit 12, the weight acquiring unit 13, the model generation unit 14, the feature amount acquiring unit 15, the computation units 16 and 16a, the output unit 17, and the model conversion unit 19 are implemented by software, firmware, or a combination of software and firmware. That is, the selection information acquiring unit 11, the model identification unit 12, the weight acquiring unit 13, the model generation unit 14, the feature amount acquiring unit 15, the computation units 16 and 16a, the output unit 17, and the model conversion unit 19 are implemented by the CPU 905 that executes programs stored in an HDD 902, the memory 906, and the like, or the processing circuit 901 such as a system large scale integration (LSI). It can also be said that the programs stored in the HDD 902, the memory 906, and the like cause a computer to execute the procedures or methods performed by the selection information acquiring unit 11, the model identification unit 12, the weight acquiring unit 13, the model generation unit 14, the feature amount acquiring unit 15, the computation units 16 and 16a, the output unit 17, and the model conversion unit 19. Herein, the memory 906 corresponds to, for example, a nonvolatile or volatile semiconductor memory, such as a RAM, a read only memory (ROM), a flash memory, an erasable programmable read only memory (EPROM), and an electrically erasable programmable read only memory (EEPROM), a magnetic disk, a flexible disk, an optical disk, a compact disk, a mini disk, a digital versatile disc (DVD), or the like.

Note that the functions of the selection information acquiring unit 11, the model identification unit 12, the weight acquiring unit 13, the model generation unit 14, the feature amount acquiring unit 15, the computation units 16 and 16a, the output unit 17 and the model conversion unit 19 may be partially implemented by dedicated hardware, and partially implemented by software or firmware. For example, the functions of the selection information acquiring unit 11, the weight acquiring unit 13, and the output unit 17 can be implemented by the processing circuit 901 as dedicated hardware, and the functions of the model identification unit 12, the model generation unit 14, the feature amount acquiring unit 15, the computation units 16 and 16a, and the model conversion unit 19 can be implemented by the processing circuit 901 reading out and executing the program stored in the memory 906.

The storage unit 18 includes the HDD 902. The storage unit 18 may include an SDD (not illustrated).

Moreover, the model generation devices 1, 1a and 1b each include an input interface device 903 and an output interface device 904 that perform wired communication or wireless communication with a device such as a driving control device (not illustrated).

In the above-described first to third embodiments, the model generation devices 1, 1a, and 1b are mounted on the in-vehicle device 100 mounted on the vehicle, and generate a model to be used for driving control of the vehicle. However, this is merely an example. For example, the model generation devices 1, 1a, and 1b may be mounted on a detection device that performs computation of detecting a defective product or the like from among a plurality of products using models specialized for respective products in a manufacturing line of a factory that manufactures the products, and may generate the models specialized for the respective products. The model generation devices 1, 1a and 1b generate the models specialized for the respective products not on the basis of learning but on the basis of the weight map and the weights acquired from, for example, a device outside the model generation device 1, so that the detection device can use a model with high accuracy in detection of a defective product or the like for each product. In addition, the detection device can reduce calculation resources when a plurality of models each having a common portion are generated at once.

As described above, the model generation devices 1, 1a and 1b according to the first to third embodiments can be applied to various devices that need to perform control by switching a plurality of models.

Note that it is possible to freely combine the embodiments, to modify any components of the embodiments, or to omit any components in the embodiments.

### INDUSTRIAL APPLICABILITY

The model generation device according to the present disclosure makes it possible to obtain pieces of information suitable for various conditions without requiring storage of all data indicating various neural network models suitable for the various conditions. Therefore, the model generation device can be applied to a model generation device that generates neural network models in various devices that need to perform control by switching the models.

### REFERENCE SIGNS LIST

1, 1a, 1b: model generation device, 11: selection information acquiring unit, 12: model identification unit, 13: weight acquiring unit, 14: model generation unit, 15: feature amount acquiring unit, 16, 16a: computation unit, 161: first computation unit, 162: second computation unit, 17: output unit, 18: storage unit, 19: model conversion unit, 901: processing circuit, 902: HDD, 903: input interface device, 904: output interface device, 905: CPU, 906: memory, 100: in-vehicle device

1. A model generation device comprising:
processing circuitry
to acquire selection information for identifying at least one target model to be generated from among a plurality of generable neural network models;
to identify the at least one target model on a basis of the selection information acquired;
to acquire a weight of the at least one target model identified; and
to generate the at least one target model identified on a basis of the weight acquired and a weight map in which structure information on a structure of each of the plurality of neural network models and information for mapping a weight in the structure are defined.

2. The model generation device according to claim 1, wherein
the processing circuitry acquires a feature amount to be input to the at least one target model generated; and
the processing circuitry performs computation using the at least one target model generated on a basis of the feature amount acquired.

3. The model generation device according to claim 1, wherein
the processing circuitry to optimizes the at least one target model generated in a way depending on the at least one target model and a device to perform computation using the at least one target model, and loads the optimized at least one target model into the device.

4. The model generation device according to claim 2, wherein
the processing circuitry generates the at least one target model including a plurality of target models at once to which the same feature amount is to be input,
the plurality of target models each have a portion having a common structure and a common weight mapped in the structure, and
in a case where the plurality of target models generated each have the portion having the common structure and the common weight mapped in the structure, the processing circuitry causes the plurality of target models to share a result of computation performed using the portion.

5. An in-vehicle device comprising
the model generation device according to claim 1.

6. A model generation method comprising:
acquiring selection information for identifying at least one target model to be generated from among a plurality of generable neural network models;
identifying the at least one target model on a basis of the selection information acquired;
acquiring a weight of the at least one target model identified; and
generating the at least one target model identified on a basis of the weight acquired and a weight map in which structure information on a structure of each of the plurality of neural network models and information for mapping a weight in the structure are defined.
